(19) United States
(12) Patent Application Publication
(10) Pub. No.: US 2012/0105630 A1
(43) Pub. Date: May 3, 2012

(54) ELECTRONIC DEVICE AND METHOD FOR RECOGNIZING AND TRACKING SUSPECTS

(75) Inventor: XIANG CAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/115,076

(22) Filed: May 24, 2011

(30) Foreign Application Priority Data
Oct. 28, 2010 (CN) 201010523407.4

(51) Int. Cl. H04N 7/18

(52) U.S. Cl. 348/143

(57) ABSTRACT

An electronic device is connected to a controller. The controller is connected to an infrared light-emitting diode (LED), a camera and one or more infrared illuminators installed in a monitored area. The camera captures images of the monitored area. The electronic device selects a person appears in the images as a tracking target, determines movement information of the tracking target in the monitored area, and controls the camera to track the tracking target according to the movement information. The infrared LED emits infrared rays. The infrared illuminators determine intensity variation of the infrared rays that penetrated the tracking target, generate a pulse signal based on the intensity variation. The electronic device determines if a frequency of a digital signal, which is converted from the pulse signal, falls within a normal human heartbeat rate range, to determine if the tracking target is a suspect.

### BACKGROUND

1. Technical Field

Embodiments of the present disclosure relate to monitoring systems and methods, and particularly to an electronic device and method for recognizing and tracking suspects using the electronic device.

2. Description of Related Art

Cameras are widely used for remote security management. A camera captures real time images of a monitored area and sends the real time images to a control computer. The control computer may determine that a suspect has appeared in the monitored area based on the real time image, and control the camera to recognize and follow the suspect. However, at present, the suspect is mostly recognized and followed based on shape characteristics. If the suspect mingles with a crowd and mixes in with other people or objects, it is difficult to recognize the suspect.

### BRIEF DESCRIPTION OF THE DRAWINGS

FIG. 1 is a block diagram of one embodiment of an electronic device comprising a suspect recognizing and tracking system.

FIG. 2 is a block diagram of one embodiment of function modules of the suspect recognizing and tracking system in FIG. 1.

FIG. 3A and FIG. 3B are a flowchart of one embodiment of a method for recognizing and tracking suspects using the electronic device in FIG. 1.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

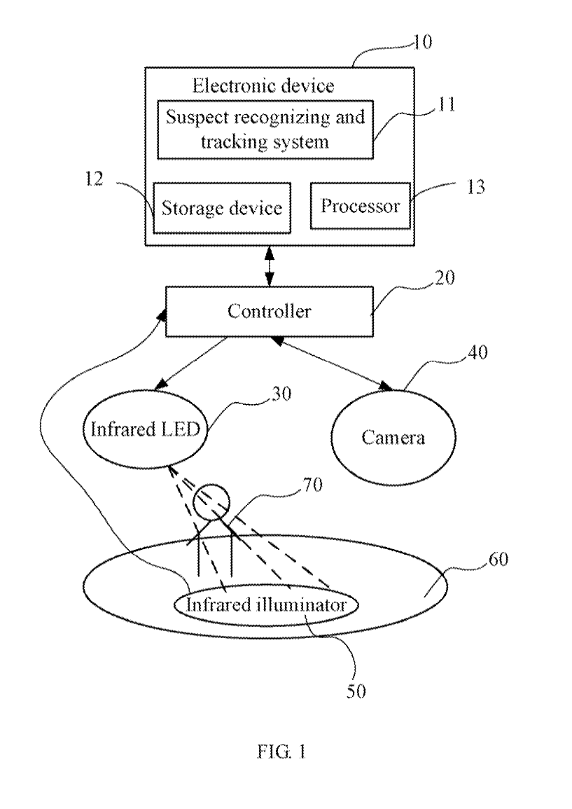

FIG. 1 is a block diagram of one embodiment of an electronic device 10. In one embodiment, the electronic device 10 includes a suspect recognizing and tracking system 11 (hereinafter, the “system 11”), a storage device 12, and a processor 13. The electronic device 10 may be a computer or a server. In one embodiment, the electronic device is electronically connected to a controller 20. The controller 20 is electronically connected to an infrared light-emitting diode (LED) 30, a camera 40, and one or more infrared illuminators 50 positioned around a monitored area. For example, in one embodiment, the one or more infrared illuminators 50 can be installed under the floor 60 of the monitored area. In other embodiments, the one or more infrared illuminators 50 may be installed along or in a wall of the monitored area. In such an embodiment, the infrared LED 30 can be installed above the camera 40 and bound together with the camera 40, so when the camera 40 is moving, the infrared LED 30 follow the same movements as the camera 40.

The camera 40 captures images of the monitored area, and sends the images to the electronic device 10 via the controller 20. The system 11 selects an object (e.g., a person 70 shown in FIG. 1) that appears in the monitored area as a tracking target based on the images, determines movement information of the tracking target in the monitored area by analyzing the images, generates control commands based on the movement information to control camera 40 to track the tracking target.

The system 11 further receives and analyzes a digital signal converted from a pulse signal to obtain a frequency of the digital signal. The pulse signal is generated by an infrared illuminator 60 based on intensity variation of the infrared rays, which are generated by the infrared LED 30 and which penetrate the tracking target. The system 11 determines if the frequency of the digital signal falls within a normal human heartbeat rate range, to determine if the tracking target is a suspect. If the tracking target is determined as a suspect, the system 11 keeps tracking the tracking target (detailed description will be given in below paragraphs). It is understood that, along with beating of a person's heart, translucency of different parts of the human body varies, which causes the intensity variation of the infrared rays that penetrate the human body (such as ears or fingers of people). A frequency of the translucency variation can be regarded the same as a frequency of a heartbeat, and a frequency of the intensity variation of the infrared rays can be regarded the same as the frequency of the translucency variation, therefore the frequency of the intensity variation of the infrared rays is regarded as the same as the frequency of the heartbeat.

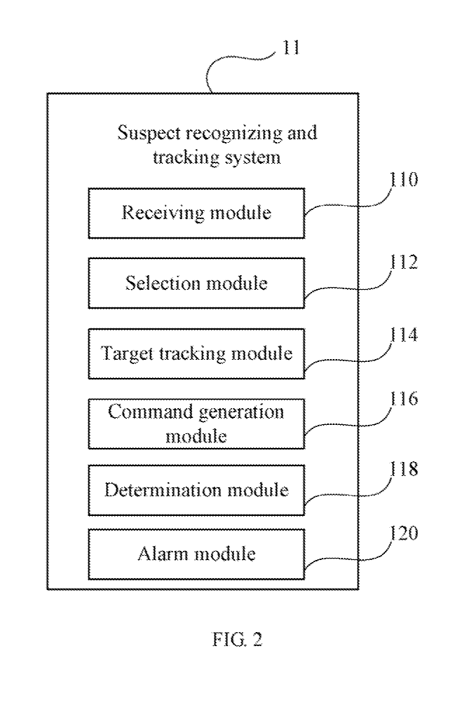

As shown in FIG. 2, the system 11 includes a plurality of function modules. The function modules may comprise computerized code in the form of one or more programs that are stored in the storage device 12. The computerized code includes instructions that are executed by the processor 13 to provide above-mentioned functions of the system 11. In one embodiment, the system 11 includes a receiving module 110, a selection module 112, a target tracking module 114, a command generation module 116, a determination module 118, and an alarm module 120.

The receiving module 110 is operable to receive the images of the monitored area, which are captured by the camera 40 at different times, via the controller 20.

The selection module 112 is operable to select a person in an image as a tracking target. For example, a person A in a first image of the monitored area captured at the time t=1s can be selected as the tracking target.

The target tracking module 114 is operable to determine a position Pn (Xn, Yn, Zn) of the tracking target in each image using an algorithm. In this embodiment, the algorithm may be a continuously adaptive mean shift method, which may search and position the tracking target in the images based on color characteristics of the tracking target. For example, if a main color of the tracking target is red, the target tracking module 114 regards a size of a rectangular box that is bounded by red color in the first image as the size of the tracking target, and regards a center of the rectangular box as the position P1 (X1, Y1, Z1) of the tracking target in the first image.

The target tracking module 114 is operable to determine a movement direction and a movement distance of the tracking target in the monitored area according to the position information of the tracking target in different images. For example, if a position of the tracking target in a second image is P2 (X2, Y2, Z2), the target tracking module 114 determines the movement direction and the movement distance of the tracking target in the monitored area according to a difference of P2 (X2, Y2, Z2) and P1 (X1, Y1, Z1).

The command generation module 116 is operable to generate a control command according to the movement direction and the movement distance of the tracking target, and send the control command to the controller 20. The controller 20 controls the camera 40 to move along the movement direction by the movement distance, so that the tracking target keeps in a viewable range of the camera 40. Because the camera 40 makes a central projection on a plane, only a limited part of the monitored area can be photographed. The viewable angle is a parameter describing a range in the monitored area that can be viewed by the camera 40.

While controlling movements of the camera 40, the controller 20 further controls the infrared LED 30 to emit infrared rays to irradiate the tracking target. The infrared illuminator 50 receives infrared rays that penetrate the tracking target, determines intensity variation of the penetrated infrared rays, generates the pulse signal based on the intensity variation, and sends the pulse signal to the controller 20. The controller 20 converts the pulse signal into a digital signal, and sends the digital signal to the electronic device 10.

The receiving module 111 is further operable to receive the digital signal. The determination module 118 is operable to determine the frequency of the digital signal, and determine if the frequency falls within the normal human heartbeat rate range, such as 60-110 times per minute. If the frequency of the digital signal falls out of the normal human heartbeat rate range, the determination module 118 determines that the tracking target is the suspect, and the alarm module 120 generates an alert to notify a user of the electronic device 10.

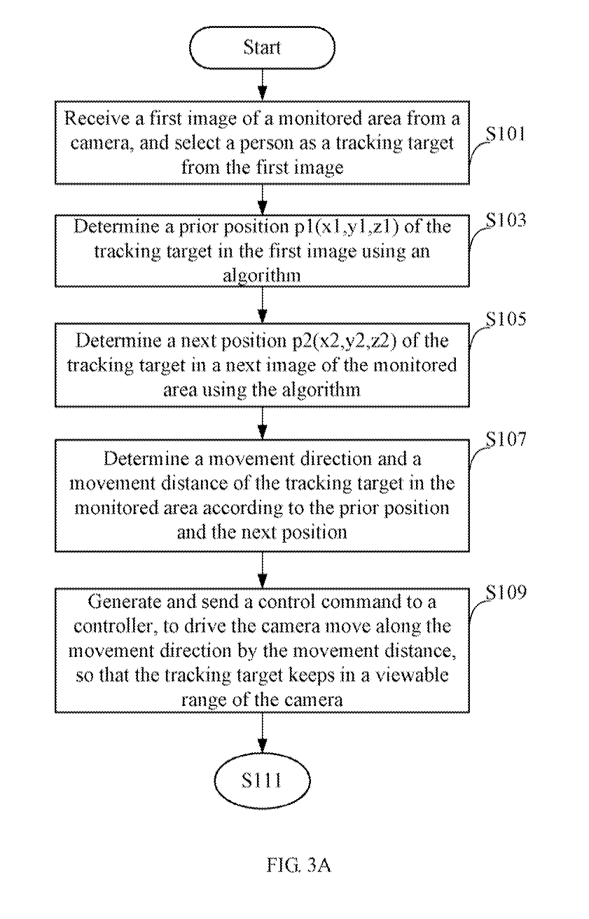

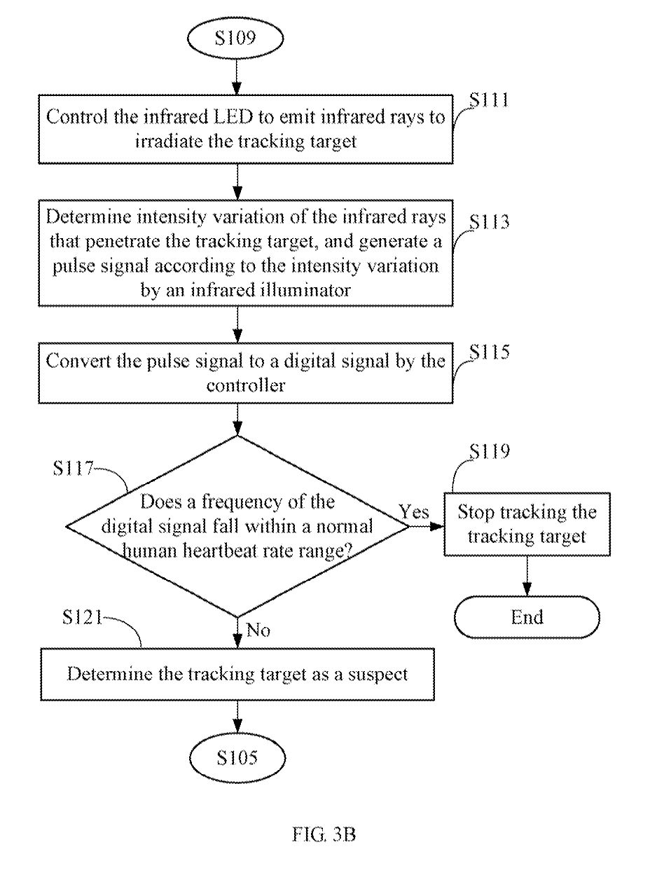

FIG. 3A and FIG. 3B are a flowchart of one embodiment of a method for recognizing and tracking a suspect using the electronic device 10. Depending on the embodiment, additional blocks may be added, others removed, and the ordering of the blocks may be changed.

In block S101, the receiving module 110 receives a first image of the monitored area captured by the camera 40, the selection module 112 selects a person in the first image as a tracking target.

In block S103, the target tracking module 114 determines a prior position P1 (X1, Y1, Z1) of the tracking target in the first image using an algorithm. In this embodiment, the algorithm is the continuously adaptive mean shift method as described above.

In block S105, the receiving module 110 receives a next image of the monitored area captured by the camera 40, the target tracking module 114 determines a next position P1 (X1, Y1, Z1) of the tracking target in the next image using the algorithm. It is understood that, every time a new received image is regarded as a next image, and the previous mentioned next image is regarded as the prior image.

In block S107, the target tracking module 114 determines a movement direction and a movement distance of the tracking target in the monitored area according to the prior position and the next position of the tracking target.

In block S109, the command generation module 116 generates a control command according to the movement direction and the movement distance of the tracking target, and sends the control command to the controller 20. After receiving the control command, the controller 20 controls the camera 40 to move along the movement direction, the movement distance, so the tracking target keeps in a viewable range of the camera 40.

In block S111, the controller 20 controls the infrared LED 30 to emit infrared rays to irradiate the tracking target.

In block S113, the infrared illuminator 50 receives infrared rays that penetrate the tracking target, determines intensity variation of the penetrated infrared rays, generates a pulse signal based on the intensity variation, and sends the pulse signal to the controller 20.

In block S115, the controller 20 converts the pulse signal to a digital signal, and sends the digital signal to the electronic device 10.

In block S117, the determination module 118 determines a frequency of the digital signal, and determines if the frequency falls within the normal human heartbeat rate range, such as 60-110 times per minute. If the frequency of the digital signal falls within the normal human heartbeat rate range, in block S119, the determination module 118 determines that the tracking target is not a suspect, then the command generation module 116 generates a stop command, and sends the stop command to the controller 20 to stop tracking the tracking target, then the procedure ends. Otherwise, if the frequency of the digital signal falls out of the normal human heartbeat rate range, in block S121, the determination module 118 determines that the tracking target is a suspect, and the alarm module 120 generates an alert to notify a user of the electronic device 10. Then, the procedure goes to block S105 to keep tracking the suspect.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for recognizing and tracking suspects using an electronic device, the electronic device being electronically connected to a controller, the controller being electronically connected to an infrared light-emitting diode (LED), a camera and one or more infrared illuminators installed in a monitored area, the method comprising:
receiving images of the monitored area captured by the camera at different times via the controller;
selecting a person in the images as a tracking target;
determining a movement direction and a movement distance of the tracking target in the monitored area according to position information of the tracking target in the images;
generating a control command according to the movement direction and the movement distance of the tracking target, and sending the control command to the controller, to control the camera to move along the movement direction by the movement distance, so that the tracking target keeps in a viewable range of the camera;
controlling the infrared LED to emit infrared rays, determining intensity variation of infrared rays that penetrate the tracking target, generating a pulse signal based on the intensity variation, and sending the pulse signal to the controller; and
determining the tracking target as a suspect and keeping track of the suspect, in response that a frequency of a digital signal, which is converted from the pulse signal, falls out of a normal human heartbeat rate range.

2. The method of claim 1, further comprising: generating an alert to notify a user of the electronic device of the suspect.

3. The method of claim 1, further comprising: stop tracking the tracking target in response that the frequency of the digital signal falls within the normal human heartbeat rate range.

4. The method of claim 1, wherein the infrared LED is installed above the camera and bounded together with the camera, so that the infrared LED do the same movement as the camera.

5. The method of claim 1, wherein the one or more infrared illuminators are installed under the floor or installed along or in the wall of the monitored area.

6. The method of claim 1, wherein the position information of the tracking target in the images is determined based on a continuously adaptive mean shift method, which searches and positions the tracking target in the images based on color characteristics of the tracking target.

7. An electronic device, the electronic device being electronically connected to a controller, the controller being electronically connected to an infrared light-emitting diode (LED), a camera and one or more infrared illuminators installed in a monitored area, the electronic device comprising:
a storage device;
a processor; and
one or more programs that are stored in the storage device and are executed by the at processor, the one or more programs comprising:
a receiving module operable to receive images of the monitored area captured by the camera at different times via the controller;
a selection module operable to select a person in the images as a tracking target;
a target tracking module operable to determine a movement direction and a movement distance of the tracking target in the monitored area according to position information of the tracking target in different images, generate and send a control command to the controller, to control the camera to move along the movement direction by the movement distance, so that the tracking target keeps in a viewable range of the camera, and control the infrared LED to emit infrared rays, determine intensity variation of infrared rays that penetrate the tracking target, generate a pulse signal based on the intensity variation, and send the pulse signal to the controller; and
a determination module operable to determine the tracking target as a suspect and keeping track of the suspect, in response that a frequency of a digital signal, which is converted from the pulse signal, falls out of a normal human heartbeat rate range.

8. The electronic device of claim 7, wherein the one or more programs further comprise an alarm module operable to generate an alert to notify a user of the electronic device of the suspect.

9. The electronic device of claim 7, wherein the command generation module is further operable to generate a stop command, and send the stop command to the controller to stop tracking the tracking target, in response that the frequency of the digital signal falls within the normal human heartbeat rate range.

10. The electronic device of claim 7, wherein the infrared LED is installed above the camera and bounded together with the camera, so that the infrared LED do the same movement as the camera.

11. The electronic device of claim 7, wherein the one or more infrared illuminators are installed under the floor or installed along or in the wall of the monitored area.

12. The electronic device of claim 7, wherein the position information of the tracking target in the images is determined based on a continuously adaptive mean shift method, which searches and positions the tracking target in the images based on color characteristics of the tracking target.

13. A non-transitory computer readable medium storing a set of instructions, the set of instructions capable of being executed by a processor of an electronic device to perform for recognizing and tracking suspects using an electronic device, the electronic device being electronically connected to a controller, the controller being electronically connected to an infrared light-emitting diode (LED), a camera and one or more infrared illuminators installed in a monitored area, the method comprising:
receiving images of the monitored area captured by the camera at different times via the controller;
selecting a person in the images as a tracking target;
determining a movement direction and a movement distance of the tracking target in the monitored area according to position information of the tracking target in different images;
generating a control command according to the movement direction and the movement distance of the tracking target, and sending the control command to the controller, to control the camera to move along the movement direction by the movement distance, so that the tracking target keeps in a viewable range of the camera;
controlling the infrared LED to emit infrared rays, determining intensity variation of the infrared rays that penetrate the tracking target, generating a pulse signal based on the intensity variation, and sending the pulse signal to the controller; and
determining the tracking target as a suspect and keeping track of the suspect, in response that a frequency of a digital signal, which is converted from the pulse signal falls out of a normal human heartbeat rate range.

14. The non-transitory computer readable medium of claim 13, wherein the method further comprises: generating an alert to notify a user of the electronic device of the suspect.

15. The non-transitory computer readable medium of claim 13, wherein the method further comprises: stop tracking the tracking target in response that the frequency of the digital signal fall within the normal human heartbeat rate range.

16. The non-transitory computer readable medium of claim 13, wherein the infrared LED is installed above the camera and bounded together with the camera, so that the infrared LED do the same movement as the camera.

17. The non-transitory computer readable medium of claim 13, wherein the one or more infrared illuminators are installed under the floor or installed along or in the wall of the monitored area.

18. The non-transitory computer readable medium of claim 13, wherein the position information of the tracking target in the images is determined based on a continuously adaptive mean shift method, which searches and positions the tracking target in the images based on color characteristics of the tracking target.
